(19) United States
(12) Patent Application Publication
(10) Pub. No.: US 2017/0322060 A1
(43) Pub. Date: Nov. 9, 2017

(54) ELECTROMAGNETIC FLOWMETER

(71) Applicant: Kabushiki Kaisha Toshiba, Minato-ku, Tokyo (JP)

(72) Inventor: Shinichiro SAKATA, Kawasaki Kanagawa (JP)

(73) Assignee: Kabushiki Kaisha Toshiba, Minato-ku, Tokyo (JP)

(21) Appl. No.: 15/526,996

(22) PCT Filed: Jan. 6, 2015
(86) PCT No.: PCT/JP2015/050153

§ 371 Date: May 15, 2017

(30) Foreign Application Priority Data
Nov. 17, 2014 (JP) 2014-233000

(51) Int. Cl. G01F 1/58

(52) U.S. Cl. CPC G01F 1/588

(57) ABSTRACT

According to one embodiment, an electromagnetic flowmeter includes a measurement pipe, a first coil, a second coil, core members, and an electrode. An object to be measured flows through the measurement pipe. The first coil is provided radially outside the measurement pipe, the first coil generates a magnetic field in the measurement pipe. The second coil is provided radially outside the measurement pipe and forms a pair with the first coil, the second coil generates the magnetic field in the measurement pipe. The core members are provided in an inner circumference of the first coil and an inner circumference of the second coil in a radial direction of the measurement pipe. The electrode is provided in the measurement pipe, the electrode detects induced electromotive force generated from a flow of the object to be measured through the measurement pipe. The inner circumference of the first coil, the inner circumference of the second coil, and an outer diameter of the core member have shapes such that the core members can be provided in the inner circumference of the first coil and the inner circumference of the second coil.

### FIELD

Embodiments of the present invention relate to an electromagnetic flowmeter.

### BACKGROUND

The electromagnetic flowmeter is a flowmeter which utilizes induced electromotive force occurring according to a flow rate of conductive fluid through a magnetic field. The electromagnetic flowmeter includes a permanent magnet and an excitation coil for generating the magnetic field. In general, excitation coils are provided outside a measurement pipe (detector) formed of a non-magnetic material, opposing each other, and are applied with current (hereinafter, referred to excitation current), thereby generating the magnetic field in the measurement pipe.

Measurement pipes of various diameters are available for the electromagnetic flowmeter and coils of different sizes and shapes are needed for different diameters, so that various types of coils should be prepared. Further, it is difficult for a large-sized coil for the electromagnetic flowmeter with a large diameter to adjust the distribution of the magnetic field in the measurement pipe.

### CITATION LIST

### Patent Literature

Patent Literature 1: Japanese Laid-open Patent Publication No. 2001-281028

### SUMMARY OF THE INVENTION

### Problem to be Solved by the Invention

The present invention aims to provide an electromagnetic flowmeter which makes it possible to form a coil unit formed of the coil for generating the magnetic field to be attached to the measurement pipe through which the object to be measured flows using few types of parts.

### Means for Solving Problem

To resolve the above problem, an electromagnetic flowmeter of embodiments comprises a measurement pipe through which an object to be measured flows; a first coil provided radially outside the measurement pipe, the first coil generating a magnetic field in the measurement pipe; a second coil provided radially outside the measurement pipe and forming a pair with the first coil, the second coil generating the magnetic field in the measurement pipe; core members inserted in an inner circumference of the first coil and an inner circumference of the second coil in a radial direction of the measurement pipe; and an electrode provided in the measurement pipe, the electrode detecting induced electromotive force generated from a flow of the object to be measured through the measurement pipe, wherein the inner circumference of the first coil, the inner circumference of the second coil, and an outer diameter of the core member have shapes such that the core members can be inserted in the inner circumference of the first coil and the inner circumference of the second coil.

### BRIEF DESCRIPTION OF DRAWINGS

FIG. 1 is a perspective view of an electromagnetic flowmeter according to a first embodiment of the present invention.

FIG. 2 is a cross-sectional view of a detector of the electromagnetic flowmeter in FIG. 1 along the A-A line.

FIG. 3 is a cross-sectional view of the detector of the electromagnetic flowmeter in FIG. 2 along the B-B line.

FIG. 4 is a cross-sectional view of a coil unit of the electromagnetic flowmeter in FIG. 3 along the C-C line.

FIG. 5 is a cross-sectional view of a detector of an electromagnetic flowmeter according to a second embodiment of the present invention.

FIG. 6 is a cross-sectional view of the detector of the electromagnetic flowmeter in FIG. 5 along the D-D line.

FIG. 7 is a cross-sectional view of a detector of an electromagnetic flowmeter according to a third embodiment of the present invention.

FIG. 8 is a cross-sectional view of the detector of the electromagnetic flowmeter in FIG. 7 along the E-E line.

FIG. 9 is a cross-sectional view of a detector of an electromagnetic flowmeter according to a fourth embodiment of the present invention.

FIG. 10 is a cross-sectional view of the detector of the electromagnetic flowmeter in FIG. 9 along the F-F line.

FIG. 11 is a cross-sectional view of a detector of an electromagnetic flowmeter according to a fifth embodiment of the present invention.

FIG. 12 is a cross-sectional view of the detector of the electromagnetic flowmeter in FIG. 11 along the G-G line.

FIG. 13 is a cross-sectional view of a detector of an electromagnetic flowmeter according to a sixth embodiment of the present invention.

FIG. 14 is a view of pipe arrangement in an electromagnetic flowmeter according to a seventh embodiment of the present invention.

FIG. 15 is a view of an adjusting mechanism of the electromagnetic flowmeter according to the seventh embodiment of the present invention.

### DETAILED DESCRIPTION

Embodiments of an electromagnetic flowmeter are hereinafter described with reference to the drawings.

### First Embodiment

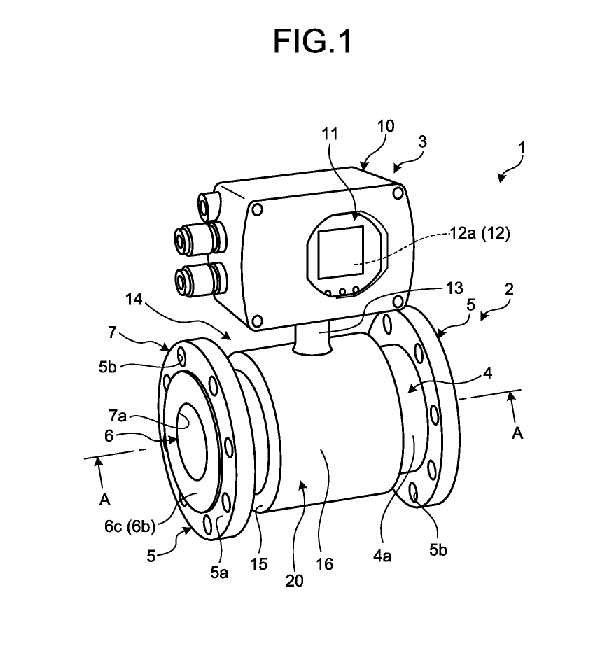

FIG. 1 is a perspective view of an electromagnetic flowmeter of a first embodiment of the present invention. An electromagnetic flowmeter 1 includes a detector 2 which detects induced electromotive force generated from a conductive object to be measured flowing through a measurement pipe and a converter 3 which converts a signal of the detected induced electromotive force to a flow amount, in which both are coupled with each other via a coupler 13. The electromagnetic flowmeter 1 may be a constant exciting (AC exciting) electromagnetic flowmeter, for example.

The detector 2 includes a pipe 7 including a flow channel 7a and a detector 14 which detects a flow amount of fluid to be measured in the flow channel 7a. The pipe 7 includes a measurement pipe 4, a flange 5, a lining 6, and a case 20.

The converter 3 includes a housing 10 and a display 12. A display screen 12a of the display 12 is covered with a panel 11. The converter 3 converts a magnitude of the induced electromotive force detected by the detector 2 to the flow amount of the object to be measured through the flow channel 7a of the measurement pipe 4. A value of the converted flow amount is displayed on the display 12 of the converter 3.

The coupler 13 couples the detector 2 with the converter 3. The coupler 13 contains wiring and the like via which the detector 2 is electrically connected to the converter 3. The wiring transfers the induced electromotive force detected by the detector 2 to the converter 3. The wiring also transfers excitation current, which is applied to later-described coil units 8 placed in the detector 2, from outside the electromagnetic flowmeter 1 to the detector 2 through the converter 3.

The flanges 5 are provided on upstream and downstream ends of the measurement pipe 4. The flange 5 is a joint for joining the detector 2 and upstream and downstream pipes (not illustrated). The flanges 5 have joint surfaces 5a on both upstream and downstream sides of the detector 2 and include a plurality of holes 5b on the joint surface 5a. The joint surface 5a of the flange 5 is joined on a joint surface of each of the upstream and downstream pipes through which the object to be measured flows. They are joined with a bolt or a nut while the holes 5b are aligned with holes on the joint surface of another pipe.

The lining 6 is provided on an inner surface 4b of the measurement pipe 4. The lining 6 is an insulating material which covers the inside of the measurement pipe 4. The lining 6 on the inside of the measurement pipe 4 of the pipe body 7 forms the flow channel 7a through which the object to be measured flows. The lining 6 provides the measurement tube 4 chemical resistance, heat resistance, and adhesion resistance against the object to be measured. The lining 6 prevents the induced electromotive force generated by the magnetic field and the object to be measured from flowing to the measurement pipe 4. The lining 6 may be formed of fluorine resin, for example.

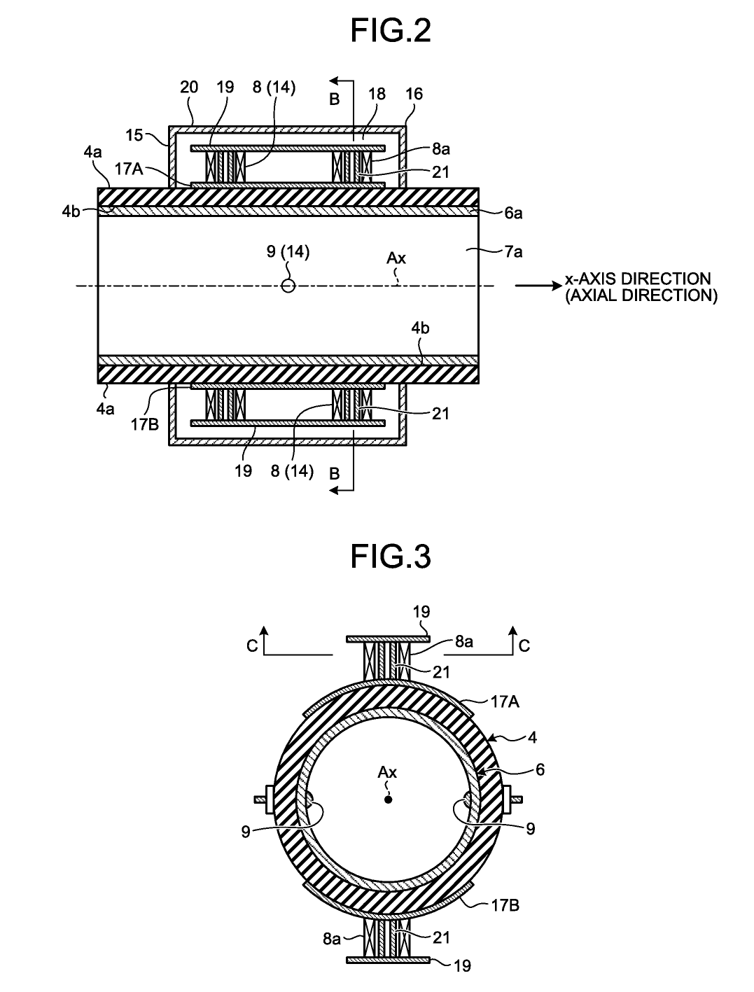

FIG. 2 is a cross-sectional view of the detector 2 of the electromagnetic flowmeter of the first embodiment along the A-A line in FIG. 1. That is, FIG. 2 is the cross-sectional view on a plane parallel to a flowing direction of the object to be measured. FIG. 2 illustrates a portion of the detector 2 between the flanges 5 (not illustrated) on both ends. Furthermore, FIG. 3 is a cross-sectional view of the detector 2 of the electromagnetic flowmeter along the B-B line in FIG. 2, and shows the cross-section of the inside of the case 20 (not illustrated). That is, FIG. 3 is the cross-sectional view on a plane orthogonal to the flowing direction of the object to be measured.

The case 20 includes peripheral walls 15 and 16. The case 20 is coupled with the converter 3 to be described later via the coupler 13. The case 20 works as the peripheral wall to cover the coil unit 8 to be described later placed radially outside the measurement pipe 4, and is welded to the measurement pipe 4.

The detector 14 includes a pair of coil units 8, 8 and a pair of electrode 9, 9 (only one of them is illustrated in FIG. 2) which is to contact with the object to be measured. The pair of coil units 8, 8 generates a constant magnetic field in the flow channel 7a of the measurement pipe 4. The pair of electrodes 9, 9 detects the induced electromotive force generated from the object to be measured passing the magnetic field while flowing through the flow channel 7a.

An axial center Ax is the axial center of the measurement pipe 4 of the detector 2. The object to be measured flows in the same direction as the axial center Ax (x-axis direction=axial direction of the measurement pipe 4) through the flow channel 7a of the measurement pipe 4. The measurement pipe 4 includes an outer surface 4a as a first surface and the inner surface 4b as a second surface. A base member 17 is provided on the outer surface 4a. The coil units 8 are each provided on the base member 17. An outer member 19 is provided on an opposite side of the base member 17 of each coil unit 8. The case 20 is provided on the outer surface 4a so as to cover the base member 17, the coil unit 8, and the outer member 19. The case 20 is fixed by welding, for example. The flange 5 is provided on the outer surface 4a of the measurement pipe 4. The pair of electrodes 9, 9 and the lining 6 are provided on the inner surface 4b of the measurement pipe 4. A line connecting the pair of electrodes 9, 9 is substantially orthogonal to the axial center Ax of the measurement pipe 4.

The lining 6 includes a cylinder portion 6a (refer to FIG. 2) and a flare portion 6b (refer to FIG. 1). The cylinder portion 6a covers the inner surface 4b of the measurement pipe 4 to protect the inner surface 4b from the object to be measured. The flare portion 6b includes an end face 6c. The end face 6c forms an outer surface of the pipe 7. The flare portion 6b contacts with an end face 5a of the flange 5 (refer to FIG. 1) to protect the end face 5a from the object to be measured.

The base member 17 includes first and second base members 17A and 17B opposing each other across the measurement pipe 4. That is, the first and second base members 17A and 17B are provided on both sides of the axial center Ax of the measurement pipe 4. The base member 17 is formed of a magnetic material. The base member 17 is fixed to the outer surface 4a of the measurement pipe 4 by welding, for example. Each of the first and second base members 17A and 17B includes a core member 21. The core member 21 is secured on the base member 17, extending radially outward from the measurement pipe 4. The core member 21 is fixed to the base member 17 by welding, for example. The core member 21 is the core of each coil unit 8.

The coil units 8 each include a cylindrical coil 8a, for example. The inner circumference of the coil 8a can contain two or more core members 21. The coil units 8 are attached to the first and second base members 17A and 17B and it is possible to insert two or more core members 21 in the cylinder of the coil 8a.

The outer members 19 are of a flat plate-like shape. The outer members 19 are provided corresponding to the first and second base members 17A and 17B. The outer members 19 each oppose the base member 17 of the coil unit 8 across the coil 8a. The outer member 19 can be secured on the core member 21 by welding, for example. Thereby, each coil unit 8 is located between the base member 17 and the outer member 19. The outer member 19 can prevent the coil unit 8 from coming out from the measurement pipe 4 in the radial direction. The coil unit 8 also functions as a support member which supports the outer member 19.

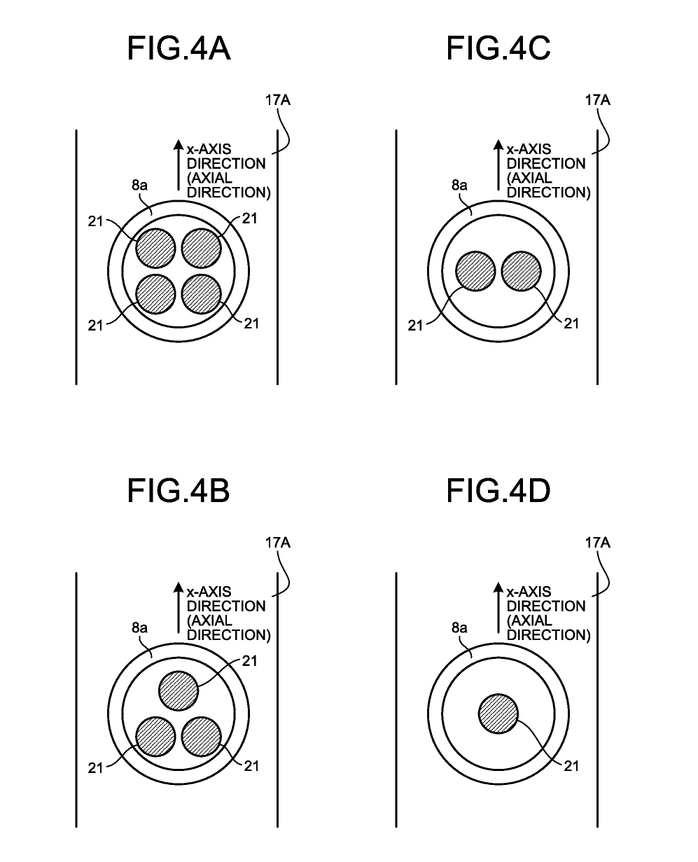

FIG. 4 is a cross-sectional view of the coil unit 8 along the C-C line in FIG. 3. FIG. 4 shows an example of the number and arrangement of core members 21 inserted in the coil 8a. The coil unit 8 in FIGS. 2 and 3 includes four core members 21 arranged as illustrated in FIG. 4(a). By changing the number of core members 21 of the coil unit 8 to three, two, and one as illustrated in FIGS. 4(b), 4(c), and 4(d), respectively, or changing the positions of the core members 21 on the inner circumference of the coil 8a, the distribution of the magnetic field is varied in the measurement pipe 4, making it possible to improve the accuracy of detection of the induced electromotive force by the pair of electrodes 9, 9. The core members 21 may be arranged on a circle at the same distance from the center of the inner circumference of the coil 8a, for example. In the present embodiment, the number and arrangement of the core members 21 inserted in the coil 8a should not be limited to those in FIG. 4 and the number may be increased or decreased and the fixed positions may be changed according to the diameter of the measurement pipe 4.

A magnetic flux inside the coil unit 8, which is generated by the excitation current to the coil 8a, spreads along the outer surface 4a of the measurement pipe 4 through the base member 17. The spread magnetic flux flows from the first base member 17A on one side toward the second base member 17B on the other side through the flow channel 7a of the measurement pipe 4. The distribution of the magnetic field in the flow channel 7a of the measurement pipe 4 is changed depending on a change in the number or position of the core members 21 inserted in the coil 8a. An increase in the number of core members 21 in the coil 8a increases the number and density of generated magnetic fluxes.

In the present embodiment, the plurality of coil units 8 are provided on the base member 17 with a spacing along the axis (x direction) of the measurement pipe 4. In this case, the density of the magnetic flux generated in the measurement pipe 4 through the base member 17 increases. The coils 8a are the same and the same number of the core members 21 is provided for each pair of coil units 8 placed across the axial center Ax of the measurement pipe 4. It is necessary to adjust the distribution of the magnetic field in the measurement pipe 4 in order to accurately detect the induced electromotive force with the pair of electrodes 9, 9 of the detector 2. The further the pair of electrodes 9, 9 from the measurement tube 4 along the axis, the lower the sensitivity of the electrodes 9, 9 relative to the induced electromotive force. Therefore, the strength of the generated magnetic field can be selected by inserting one core member 21 in the coil unit 8 closer to the pair of electrodes 9, 9 and two core members 21 in the coil unit 8 distant from the pair of electrodes 9, 9.

In the present embodiment, the coil units 8 are standardized by including the coils 8a and the core member 21s of the same specification irrespective of the diameter of the measurement pipe 4. That is, the coils 8a of the same specification including the number of windings, a diameter, a shape, a length, and a size and the core members 21 of the same specification including a length and a diameter can be used in the measurement pipe 4 in different diameters. Thereby, they can be standardized.

The strength of the magnetic field in the measurement pipe 4 with a different diameter in another electromagnetic flowmeter can be selected by increasing or decreasing the number of the core members 21 or changing their arrangement. With use of the measurement tube 4 with a larger diameter, a stronger magnetic field can be generated in the measurement pipe 4 by increasing the number of the coil units 8. Thereby, it is possible to reduce time and labor for manufacturing the electromagnetic flowmeter 1. Furthermore, by manufacturing the electromagnetic flowmeter including not various kinds of coil units in a small volume but a few kinds of coil units 8 in a large volume, it is able to reduce manufacturing costs.

In the present embodiment a clearance 18 is provided between the outer member 19 and the peripheral wall 16 of the case 20, extending along the axis (x direction) of the measurement pipe 4, as illustrated in FIG. 2. Because of this, manufacturing variations (dimensional variations) in the case 20, the base member 17, and the outer member 19 can be eliminated. Furthermore, in comparison with no clearance 18 provided, it is possible to easily and accurately attach the case 20, the base member 17, and the outer member 19 to the measurement pipe 4.

According to the present embodiment at least the peripheral wall 16 of the case 20 is made from a magnetic material such as steel, for example. Therefore, the magnetic flux flows from the first base member 17A on one side to the second base member 17B on the other side through the measurement pipe 4 and flows in the peripheral wall 16 circumferentially to return to the first base member 17A through the clearance 18. That is, the peripheral wall 16 forms at least a part of a feedback magnetic path.

Since the peripheral wall 16 functions as the feedback magnetic path, it is possible to inhibit an impact to the peripheral wall 16 from reaching the coil unit 8 and improve the reliability of the electromagnetic flowmeter 1, as compared to a conventional configuration in which the feedback magnetic path is directly connected to the core member 21. Further, owing to the peripheral wall 16 forming a part of the feedback magnetic path, the electromagnetic flowmeter 1 can be downsized from the one in which the feedback magnetic path and the peripheral wall 16 are different members.

Meanwhile, the present embodiment exemplifies a wetted electromagnetic flowmeter in which the object to be measured and the electrodes contact with each other. However, the present invention should not be limited to the wetted electromagnetic flowmeter. It may also be other measuring types, for example, a non-wetted electromagnetic flowmeter in which the object to be measured and the electrode do not contact with each other.

In the present embodiment, the coil units 8 can include cylindrically wound coils 8a which are hardened by impregnation or self-fusing coils 8a wound cylindrically.

The present embodiment can attain such effects that the constant, strong magnetic field can be generated in the measurement pipe 4, thereby improving the accuracy of the detection of the induced electromotive force by the pair of electrodes 9, 9.

### Second Embodiment

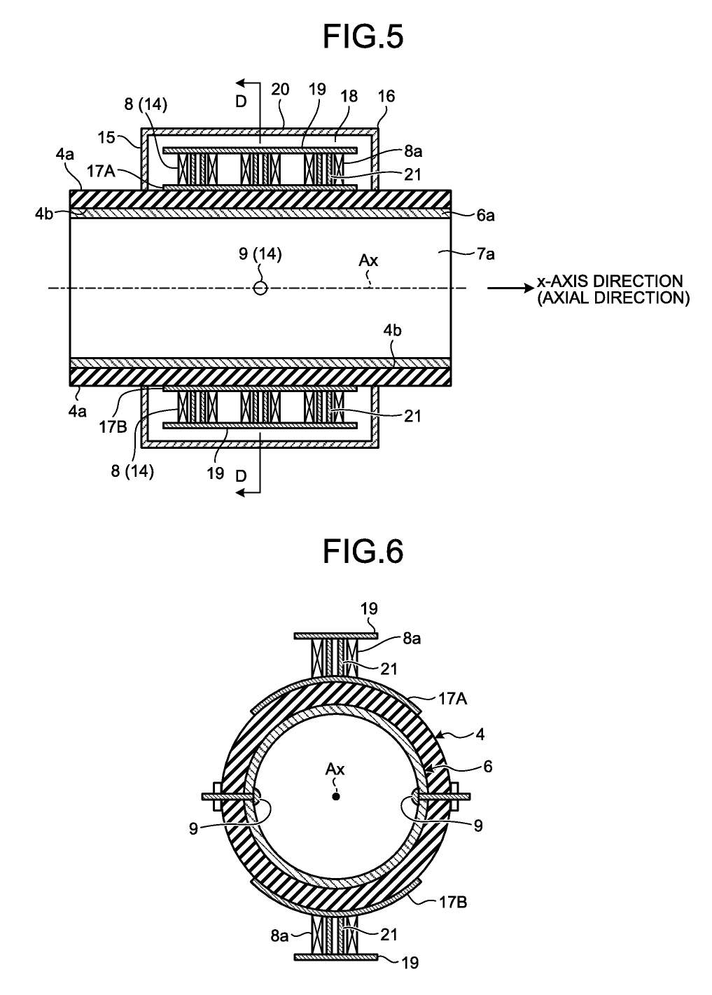

FIG. 5 illustrates an example of the detector 2 of the electromagnetic flowmeter 1 of a second embodiment, that is, a portion between the flanges 5 on both ends of the detector 2. In the present embodiment, the number of pairs of coil units 8 is increased in the axial direction (x-axis direction) from that in the first embodiment. While two pairs of coil units 8 are arranged in the measurement tube 4 in the axial direction in the first embodiment (refer to FIG. 2), three pairs of coil units 8 are arranged in this embodiment (refer to FIG. 5). By the increase in the number of coil units 8, a strong magnetic field can be generated in the flow channel 7a of the measurement pipe 4. Therefore, the electrodes 9, 9 can accurately detect induced electromotive force in the measurement pipe 4 of a larger diameter than that in the first embodiment.

FIG. 6 is a cross-sectional view of the detector 2 of the electromagnetic flowmeter along the D-D line in FIG. 5, showing the cross section of the inside of the case 20 (not illustrated). That is, FIG. 6 shows a cross-sectional view on a plane orthogonal to the flowing direction of the object to be measured.

Three pairs of coil units 8 are arranged on the measurement tube 4 along the axis (x-axis direction). The pairs of coil units 8 are arranged such that a line connecting one of the pairs of coil units 8, 8 and a line connecting the pair of electrodes 9, 9 (only one of them is illustrated in FIG. 5) provided in the measurement pipe 4 are orthogonal to each other (refer to FIG. 6). Herein, the coil 8a of each coil unit 8 is the same as that in the first embodiment and the core member 21 inserted in each coil unit 8 is also the same as that in the first embodiment.

To accurately detect the induced electromotive force with the pair of electrodes 9, 9 of the detector 2, it is necessary to adjust the distribution of the magnetic field in the measurement pipe 4. The pairs of coil units 8 on the right and left ends in FIG. 5 are arranged at a larger distance from the pair of electrodes 9, 9 than the central coil units 8. The magnetic field generated by the pairs of coil units 8 on the right and left ends is weaker in the vicinity of the electrodes 9 than the magnetic field generated by the central coil units 8, resulting in smaller induced electromotive force. Thus, larger variations by noise occur. Accordingly, the pairs of coil units 8 on both ends have a small effect on the pair of electrodes 9, 9 to detect the induced electromotive force. The central coil unit pair 8 closer to the pair of electrodes 9, 9 than the coil unit pairs 8 on the both ends largely affect the pair of electrodes 9, 9 to detect the induced electromotive force. Therefore, by inserting a larger number of core members 21 in the coil unit pairs 8 on both ends than in the central coil unit pair 8, a larger strength of magnetic field can be generated in the measurement pipe 4. For example, two core members 21 may be inserted into the coil unit pairs 8 on both ends and one core member 21 may be inserted into the central coil unit pair 8. Alternatively, two or more core members 21 may be inserted into any coil unit pair 8 and a larger number of core members 21 may be inserted into the pairs of coil units 8 on both ends than into the central coil unit pair 8.

The arrangement of the core members 21 can be changed in each coil unit 8.

In replace of the three pairs of coil units 8 in FIG. 5 in the present embodiment, a larger number of the coil units can be provided. The number of coil units 8 should not be limited to that in FIG. 5. Although the four core members 21 are arranged in the coil unit 8 in FIG. 6, the number thereof should not be limited thereto in FIG. 6.

According to the present embodiment, even and strong magnetic field can be generated in the flow channel 7a in the measurement pipe 4, which can improve the accuracy of detection of the induced electromotive force by the pair of electrodes 9, 9.

### Third Embodiment

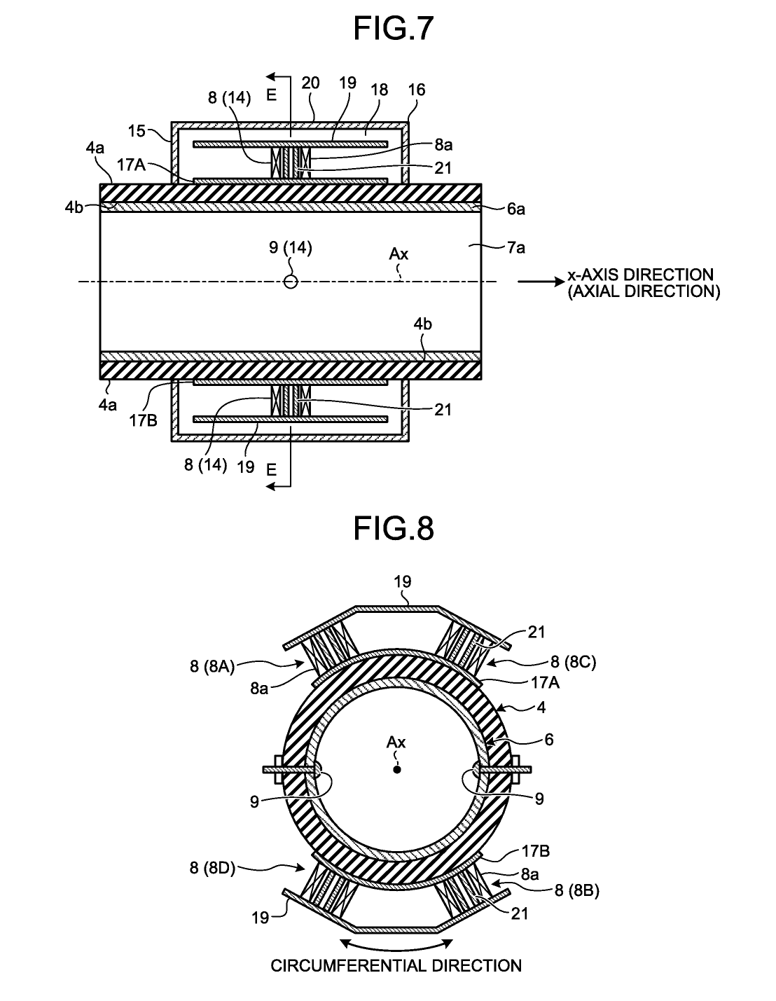

FIG. 7 illustrates an example of the detector 2 of the electromagnetic flowmeter 1 according to a third embodiment, that is, a portion between the flanges 5 on both ends of the detector 2. FIG. 8 is a cross-sectional view of the detector 2 of the electromagnetic flowmeter along the E-E line in FIG. 7 and the cross-sectional view of the inside of the case 20 (not illustrated). That is, FIG. 8 shows a cross-sectional view on a plane orthogonal to a flowing direction of the object to be measured.

In the present embodiment, a pair of coil units 8 is arranged in the positions of the pair of electrodes 9, 9 (only one of them is illustrated in FIG. 7) of the measurement pipe 4 in the axial direction as illustrated in FIG. 7. In the present embodiment, two pairs of coil units 8 (8A, 8B, 8C, and 8D in FIG. 8) are also arranged along the circumference of the measurement pipe 4 as illustrated in FIG. 8. Herein, the coil 8a of each coil unit 8 is the same as those in the first and second embodiments. The core member 21 inserted in the coil unit 8 is also the same as those in the first and second embodiments. The pair of coil units 8 oppose each other across the axial center Ax. The pair of coil units 8 may also be configured to oppose each other, not crossing the axial center Ax. In FIG. 8, the coil unit pair 8A and 8B and the coil unit pair 8C and 8D oppose each other across the axial center Ax. In FIG. 8, the coil unit pair 8A and 8D and the coil unit pair 8C and 8B oppose each other, not crossing the axial center Ax.

One side of the two pairs of coil units 8 is connected to the measurement pipe 4 through the first base member 17A and the opposite side is connected to the second base member 17B. Furthermore, the one side of the two pairs of coil units 8 is connected by the outer member 19 and the opposite side is connected by another outer member 19.

In the present embodiment, it is possible to increase or decrease the number of the core members 21 and arrange them differently in each of the coil unit 8 in pairs.

While the two pairs of coil units 8 are illustrated in FIG. 8 in the present embodiment, the number of pairs of coil units 8 may be three or larger and should not be limited thereto in FIG. 8. The number of core members 21 inserted in the pairs of coil units 8 should be at least one for one pair but should not be limited for the other pairs.

The present embodiment can attain such effects that the constant, strong magnetic field can be generated in the flow channel 7a of the measurement pipe 4, thereby improving the accuracy of the detection of the induced electromotive force by the pair of electrodes 9, 9.

### Fourth Embodiment

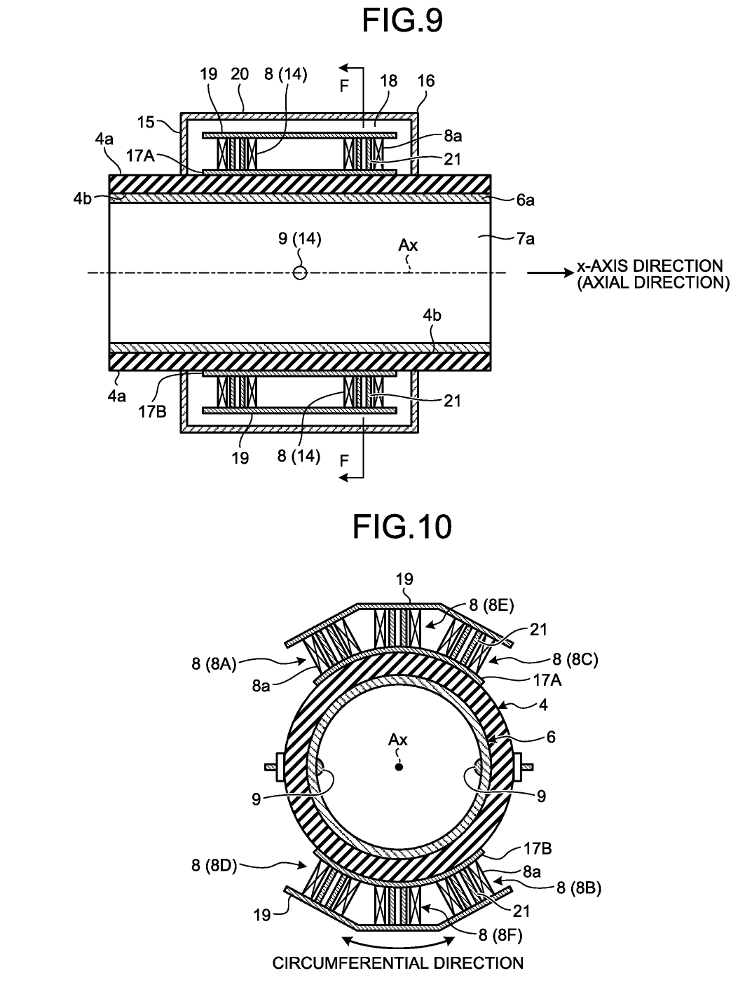

FIG. 9 shows an example of the detector 2 of the electromagnetic flowmeter 1 according to a fourth embodiment and the portion between the flanges 5 on both ends of the detector 2. FIG. 10 is a cross-sectional view of the detector 2 of the electromagnetic flowmeter along the F-F line in FIG. 9 and the cross-sectional view of the inside of the case 20 (not illustrated). That is, FIG. 10 is a cross-sectional view on a plane orthogonal to a flowing direction of the object to be measured. In the present embodiment, the number of pairs of coil units 8 is increased in a circumferential direction from that in the first embodiment. While one pair of coil units 8 is arranged on the outer circumference of the measurement pipe 4 in the circumferential direction of the measurement pipe 4 in the first embodiment (refer to FIG. 3), three pairs of coil units 8 are arranged thereon in the present embodiment (refer to FIG. 10). A constant, strong magnetic field can be generated in the measurement pipe 4 with a larger diameter than that in the first embodiment by the increase in the number of the coil units 8.

In the present embodiment, two pairs of coil units 8 are arranged on the measurement pipe 4 in the axial direction (x-axis direction), as illustrated in FIG. 9. In the present embodiment, three pairs of coil units 8 (8A, 8B, 8C, 8D, 8E and 8F in FIG. 10) are arranged along the circumference of the measurement pipe 4, as illustrated in FIG. 10. Herein, the coil 8a of each coil unit 8 is the same as those in the first to third embodiments. T core member 21 inserted in each coil unit 8 is also the same as those in the first to third embodiments. In FIG. 10, the coil units 8E and 8F form a pair, opposing each other across the axial center Ax. The remaining four coil units 8 form pairs, opposing each other across the axial center Ax. The four coil units 8 may also be configured to oppose each other, not crossing the axial center Ax. In FIG. 10, the coil unit pair 8A and 8B and the coil unit pair 8C and 8D oppose each other across the axial center Ax. In FIG. 10, the coil unit pair 8A and 8D and the coil unit pair 8C and 8B oppose each other, not crossing the axial center Ax.

One side of the three pairs of coil units 8 is connected to the measurement pipe 4 through the first base member 17A and the opposite side across the axial center Ax of the measurement pipe 4 is connected to the second base member 17B. Furthermore, the one side of the three pairs of coil units 8 is connected to the outer member 19 and the opposite side across the axial center Ax of the measurement pipe 4 is connected to another outer member 19.

In the present embodiment, it is possible to increase or decrease the number of core members 21 and change the arrangement thereof in each of the coil units 8 in pairs.

Although three pairs of coil units 8 are illustrated in FIG. 10 in the present embodiment, the number of the pairs of coil units 8 may be four or larger and should not be limited to that in FIG. 10. As for the number of the core members 21 inserted in the pairs of coil units 8, the same number of core members 21 is inserted in at least one coil unit pair 8 and the number of core members 21 for the rest of the coil unit pairs 8 should not be limited.

The electromagnetic flowmeter 1 of the present embodiment can attain such effects that a constant, strong magnetic field can be generated in the flow channel 7a of the measurement pipe 4, even with the coil units 8 arranged remotely from the pair of electrodes 9, 9 (only one of them is illustrated in FIG. 9) on the measurement pipe 4 with a larger diameter, for example, thereby improving the accuracy of the detection of the induced electromotive force by the pair of electrodes 9, 9.

### Fifth Embodiment

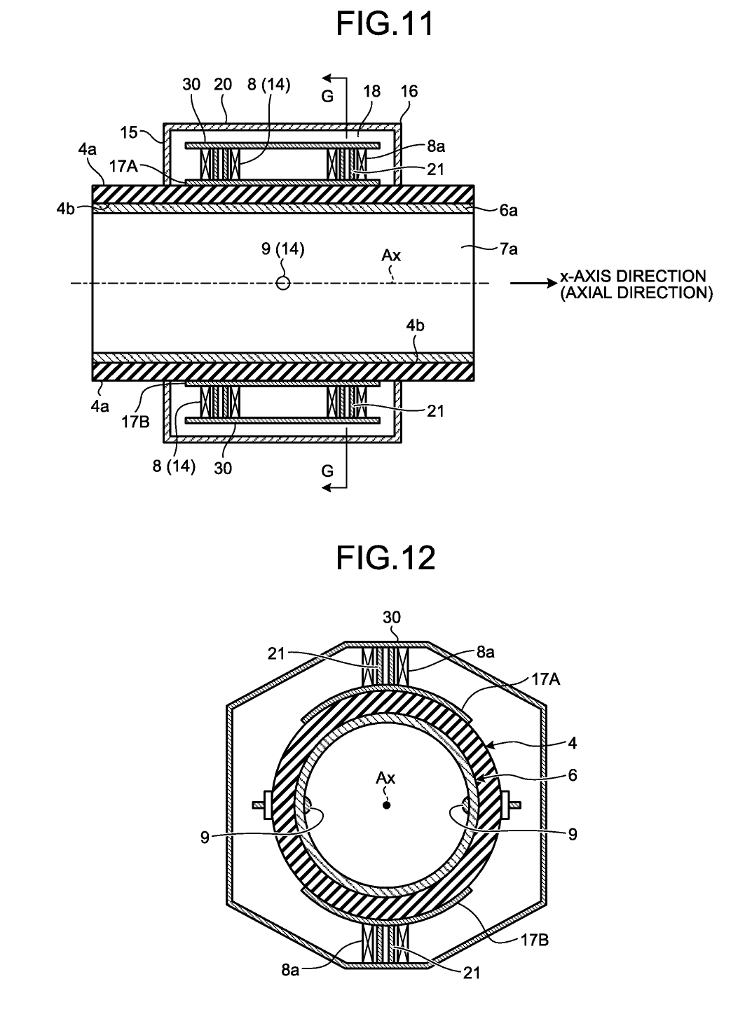

FIG. 11 shows an example of the detector 2 of the electromagnetic flowmeter 1 according to a fifth embodiment, that is, the portion between the flanges 5 on both ends of the detector 2. FIG. 12 is a cross-sectional view of the detector 2 of the electromagnetic flowmeter 1 along the G-G line in FIG. 11 and the cross-sectional view of the inside of the case 20 (not illustrated). That is, FIG. 12 is a cross-sectional view on a plane orthogonal to the flowing direction of the object to be measured. The present embodiment is expected to be applied to the electromagnetic flowmeter including the measurement pipe 4 with a substantially same diameter as that in the first embodiment.

The present embodiment includes two pairs of coil units 8, 8 arranged on the measurement pipe 4 in the axial direction (x direction) and a circular member 30 (cover member) formed of a magnetic material. The circular member 30 covers the pairs of coil units 8 around the circumference of the measurement pipe 4. The circular member 30 is opposite to the base members 17 of the coil units 8 and welded to the core members 21 by welding, for example. The circular member 30 works to cover the coil units 8. The circular member 30 is an example of the feedback magnetic path. By the circular member 30 as the feedback magnetic path, it is made possible to generate a strong magnetic field in the flow channel 7a of the measurement pipe 4 and improve the accuracy of the detection of the induced electromotive force by the pair of electrodes 9, 9.

Herein, the coil units 8 each includes the cylindrical coil 8a, for example. The inner circumference of the coil 8a can contain two or more core members 21. The present embodiment achieves such effects that a strong magnetic field can be generated in the flow channel 7a of the measurement pipe 4 by increasing or decreasing the number of core members 21 in the coil units 8 and changing the arrangement thereof.

### Sixth Embodiment

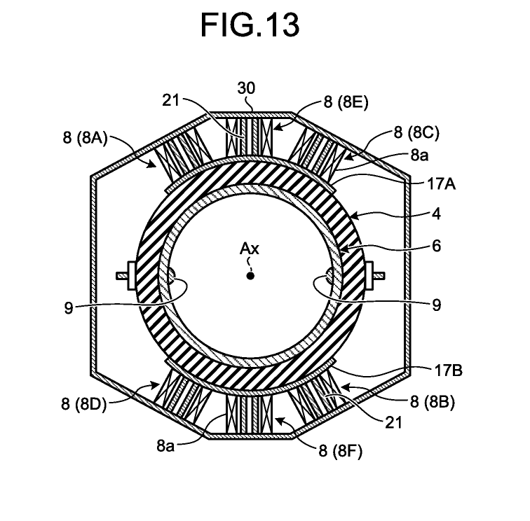

FIG. 13 illustrates an example of the detector 2 of the electromagnetic flowmeter 1 according to a sixth embodiment and a cross-sectional view on a plane orthogonal to the flowing direction of the object to be measured. The number of the pairs of coil units 8 arranged along the circumference of the measurement pipe 4 is increased from that in the fifth embodiment. With use of the measurement pipe 4 with a further larger diameter, it is possible to generate a strong magnetic field in the flow channel 7a of the measurement pipe 4 by increasing the number of the pairs of coil units 8 along the circumference.

In FIG. 13, three pairs of coil units 8 (8A, 8B, 8C, 8D, 8E, and 8F in FIG. 13) are arranged along the circumference of the measurement pipe 4. In FIG. 13, the coil units 8E and 8F form a pair, opposing each other across the axial center Ax. The Remaining four coil units 8 form pairs, opposing each other across the axial center Ax. The four coil units 8 may also be configured to oppose each other without crossing the axial center Ax. In FIG. 13, the coil unit pair 8A and 8B and the coil unit pair 8C and 8D oppose each other across the axial center Ax. In FIG. 13, the coil unit pair 8A and 8D and the coil unit pair 8C and 8B oppose each other without crossing the axial center Ax.

The coil units 8, 8 in pairs each include the cylindrical coil 8a, for example. The inner circumference of the coil 8a can contain two or more core members 21. The present embodiment includes the circular member 30 as an example of the feedback magnetic path. By the circular member 30 as the feedback magnetic path, it is made possible to generate a strong magnetic field in the flow channel 7a in the measurement pipe 4, and improve the accuracy of the detection of the induced electromotive force by the pair of electrodes 9, 9.

The present embodiment has achieves such effects that by of increasing or decreasing the number of core members 21 and changing arrangement thereof in the coil units 8, a strong magnetic can be generated in the flow channel 7a in the measurement pipe 4.

### Seventh Embodiment

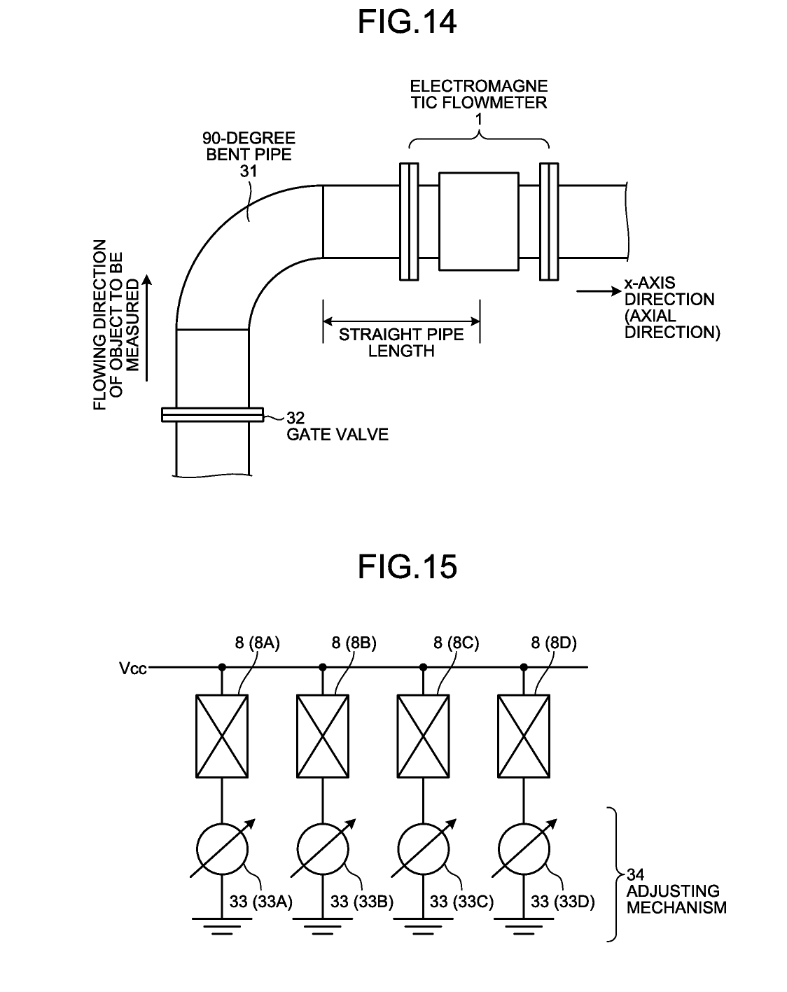

The electromagnetic flowmeter 1 in the present embodiment has the same configuration as that of the electromagnetic flowmeter 1 in FIG. 8. FIG. 14 shows an example of pipe arrangement of the electromagnetic flowmeter 1 of the present embodiment. The right and left ends of the electromagnetic flowmeter 1 are fitted to other pipes. A left-side pipe is upstream and the object to be measured flows from the left pipe to the electromagnetic flowmeter 1 in the x-axis direction.

The electromagnetic flowmeter 1 can accurately measure the flow amount of the object to be measured while flowing constantly and stably. Therefore, it is preferable to place the electromagnetic flowmeter 1 between two straight pipes. When the diameter of the measurement pipe of the electromagnetic flowmeter 1 is defined to be D, it is preferable to connect pipes of straight pipe length of 5D or longer, five times the diameter of the measurement pipe, to the detector at both upstream and downstream ends of the electromagnetic flowmeter.

However, depending on a pipe arrangement, pipes of sufficiently long straight pipe length cannot be used and the electromagnetic flowmeter 1 has to be placed next to a 90-degree bent pipe 31 as illustrated in FIG. 14. The 90-degree bent pipe 31 has a 90-degree curved shape. Further, a gate valve 32 which adjusts the flow amount of the object to be measured may be provided at a straight pipe length of 5D or less from the electromagnetic flowmeter. In such a case, the object to be measured non-axisymmetrically flows (hereinafter, referred to as drift) through a flow channel 7a in the measurement pipe 4 of the electromagnetic flowmeter 1, lowering the accuracy of the detection of the induced electromotive force.

The electromagnetic flowmeter 1 of the present embodiment is configured to adjust excitation currents flowing to the pairs of coil units 8 by distribution of a magnetic field generated in the measurement pipe 4 to adjust the distribution of the magnetic field.

Since the coil units 8 are welded and covered with the peripheral walls 15 and 16 after the assembly of the electromagnetic flowmeter 1, it is not possible to adjust the number of cores inserted in the coils 8a after the assembly (refer to FIG. 1). Therefore, the converter 3 of the electromagnetic flowmeter 1 is provided to adjust the flows of the excitation current to the coil units 8 in order to adjust the distribution of the magnetic field generated inside the measurement pipe 4.

FIG. 15 illustrates an example of an adjusting mechanism 34 which adjusts the flows of excitation current to the coil units 8. The converter 3 includes the adjusting mechanism 34 which adjusts the excitation current. With use of the pairs of coil units 8 (8A, 8B, 8C, and 8D in FIG. 15), a drive unit 33 (33A, 33B, 33C, and 33D in FIG. 15) is connected to each of the coil units 8 forming the pairs. The drive units 33 are configured to adjust the flows of excitation current to the coil units 8 when applied with a voltage Vcc. The adjusting mechanism 34 can adjust the flow of the excitation current to each coil unit 8 by controlling each of the drive units 33 connected to the coil units 8. Thereby, the adjusting mechanism 34 can adjust an electric field generated in the measurement pipe 4.

As described above, the present embodiment achieves such effects that the induced electromotive force can be detected accurately from the drift of the object to be measured by adjusting the flow of the excitation current to each coil unit 8 by the distribution of the magnetic field generated inside the measurement pipe 4.

However, even if the magnetic field distribution in the measurement pipe 4 is adjusted at the time of installing the electromagnetic flowmeter 1 by the adjustment of the excitation currents as described above, a greatly disturbed flow (hereinafter, referred to as disturbed flow) of the object to be measured may occur in the electromagnetic flowmeter 1 due to the circumstances after the piping, causing a difference between a measured value and an actual flow amount.

With a difference between the actual flow amount of the object to be measured and a measured value calculated by the electromagnetic flowmeter 1, the adjusting mechanism 34 can adjust the flows of excitation current to the coil units 8 to thereby perform calibration by actual flow and eliminate the difference between the measured value and the actual flow amount.

To correct an error between the measured amount of the electromagnetic flowmeter 1 and the actual flow of the object to be measured, it is necessary to adjust the distribution of the magnetic field generated in the measurement pipe 4. Since the coil units 8 are welded and covered with the peripheral walls 15 and 16 after the assembly of the electromagnetic flowmeter 1, it is not possible to adjust the number of cores inserted in the coils 8a after the assembly (refer to FIG. 1). Therefore, the converter 3 of the electromagnetic flowmeter 1 adjusts the flows of excitation current to the coil units 8 to thereby adjust the distribution of the magnetic field generated in the flow channel 7a of the measurement pipe 4. The drive units 33 are connected to the respective coil units 8 forming the pairs so that the current amount of the flows of excitation current can be adjusted by controlling each of the drive units 33.

As described above, with occurrence of a disturbed flow, it is possible to generate the distribution of the magnetic field to inhibit the error between the measured amount of the electromagnetic flowmeter 1 and the actual flow of the object to be measured by adjusting the flows of excitation current to the coil units 8 according to the distribution of the magnetic field generated inside the measurement pipe 4. The present embodiment achieves such effects that the difference between the measured flow amount of the object to be measured in the electromagnetic flowmeter 1 and the actual flow amount can be eliminated.

The above-described first to seventh embodiments illustrate the wetted electromagnetic flowmeter in which the object to be measured contacts with the electrodes. By covering the inner surface of the measurement pipe except the electrodes 9 with the lining 6, the electrodes 9 can improve the accuracy of the detection of the induced electromotive force. However, the present invention should not be limited to the wetted electromagnetic flowmeter and may also be other measuring types, for example, the non-wetted electromagnetic flowmeter in which the object to be measured and the electrodes 9 do not contact with each other.

There are a combined electromagnetic flowmeter and a separated electromagnetic flowmeter, the combined type in which the detector 2 is integrated with the converter 3 which amplifies and converts the signal of the induced electromotive force detected by the detector 2 for flow amount display and the separated type in which they are separated from each other. The present embodiment is applicable to either of the combined type and separated type.

Although the adjusting mechanism 34 of the seventh embodiment is configured that the drive units 33 adjust the flows of excitation current to the coil units 8, the configuration of the adjusting mechanism 34 should not be limited thereto. Further, the adjusting mechanism 34 is incorporated in the converter 3 in the seventh embodiment, however, the adjusting mechanism 34 and the converter 3 may not be located in the same housing but externally connected.

Although several embodiments of the present invention are described, the embodiments are merely presented as examples and the scope of the invention is not limited thereto. The novel embodiments may be carried out in other various modes and it is also possible to make various omissions, replacements, and changes without departing from the gist of the invention. The embodiments and variations thereof are included in the scope and gist of the invention and included in the invention recited in claims and equivalents thereof.

What is claimed is:

1. An electromagnetic flowmeter comprising:
a measurement pipe through which an object to be measured flows;
a first coil provided radially outside the measurement pipe, the first coil generating a magnetic field in the measurement pipe;
a second coil provided radially outside the measurement pipe and forming a pair with the first coil, the second coil generating the magnetic field in the measurement pipe;
core members provided in an inner circumference of the first coil and an inner circumference of the second coil in a radial direction of the measurement pipe; and
an electrode provided in the measurement pipe, the electrode detecting induced electromotive force generated from a flow of the object to be measured through the measurement pipe, wherein
the inner circumference of the first coil, the inner circumference of the second coil, and an outer diameter of the core member have shapes such that the core members can be provided in the inner circumference of the first coil and the inner circumference of the second coil,
a number of the core members provided in the inner circumference of the first coil and a number of the core members provided in the inner circumference of the second coil can be set in accordance with a diameter of the measurement pipe.

2. The electromagnetic flowmeter according to claim 1, further comprising:
a third coil provided adjacent to the first coil along a circumference of the measurement pipe, the third coil generating the magnetic field in the measurement pipe; and
a fourth coil provided adjacent to the second coil along the circumference of the measurement pipe, forming a pair with the third coil, the fourth coil generating the magnetic field in the measurement pipe, wherein
an inner circumference of the third coil, an inner circumference of the fourth coil, and the outer diameter of the core members have shapes such that the core members can be provided in the inner circumference of the third coil and the inner circumference of the fourth coil.

3. The electromagnetic flowmeter according to claim 1, further comprising:
a fifth coil provided adjacent to the first coil along an axis of the measurement pipe, the fifth coil generating the magnetic field in the measurement pipe; and
a sixth coil provided adjacent to the second coil along the axis of the measurement pipe, forming a pair with the fifth coil, the sixth coil generating the magnetic field in the measurement pipe, wherein
an inner circumference of the fifth coil, an inner circumference of the sixth coil, and the outer diameter of the core members have shapes such that the core members can be provided in the inner circumference of the fifth coil and the inner circumference of the sixth coil.

4. The electromagnetic flowmeter according to claim 2, wherein
a number of the core members provided in the inner circumference of the first coil and a number of the core members provided in the inner circumference of the second coil are different from a number of the core members provided in the inner circumference of the other coils.

5. The electromagnetic flowmeter according to claim 4, wherein a number of the core members in one of the pair of the first coil and the second coil and the pair of the fifth coil and the sixth coil is larger than a number of the core members in the other pair, the one of the pair distant from the electrode, the other pair close to the electrode.

6. The electromagnetic flowmeter according to claim 2, further comprising an adjusting mechanism which adjusts a current value of a flow of excitation current to each coil according to a distribution of the magnetic field generated in the measurement pipe.

7. The electromagnetic flowmeter according to claim 6, wherein the adjusting mechanism adjusts the current value of the flow of excitation current to each coil according to a difference between a measured value calculated from the induced electromotive force detected by the electrode and an actual flow amount of the object to be measured in the measurement pipe.
